(19) United States
(12) Patent Application Publication
(10) Pub. No.: US 2024/0411638 A1
(43) Pub. Date: Dec. 12, 2024

(54) System with Predictive Model for Server Infrastructure Failure Handling

(71) Applicant: Arista Networks, Inc., Santa Clara, CA (US)

(72) Inventors: Krishna Prabhakar, Los Altos Hills, CA (US); Rajarao Bhagya Prasad Nittur, Milpitas, CA (US); Rajesh Kumar Ganapathy Achari, Perumbavoor (IN); Madhusudhan Chitradurga Sethuram Setty, Bengaluru (IN); Pradip Das, Bangalore (IN); Premraj Lourduraj, Bangalore (IN)

(21) Appl. No.: 18/541,858

(22) Filed: Dec. 15, 2023

(30) Foreign Application Priority Data
Jun. 12, 2023 (IN) 202341039926

(51) Int. Cl. G06F 11/07; G06N 5/022

(52) U.S. Cl. CPC G06F 11/0793; G06F 11/0709; G06F 11/079; G06N 5/022

(57) ABSTRACT

A method of operating a server is provided that includes providing, with the server, one or more services relating to network access control and management of a network, predicting a failure of the server with a failure prediction model, and performing a remedial action to avoid disruption in the one or more services. The server can be a network access control and management server. The failure prediction model can be a machine-learning based server failure prediction model that is trained on past server failure events. Operated in this way, the server can operate with minimal network/server disruption so that service level agreements with various customers are maintained while reducing operational complexity.

This application claims the benefit of Indian Provisional Patent Application No. 202341039926, filed Jun. 12, 2023, which is hereby incorporated by reference herein in its entirety.

### BACKGROUND

A network can include many different types of devices such as cameras, thermostats, smoke detectors, medical or health sensors, lighting fixtures, voice-controlled speakers, printers or other output devices, controllers or other input devices, cars, wearable devices, and/or other network-connected equipment. These devices can be associated with one or more users, can have different network addresses, can be at one or more locations, and/or can have different network-related attributes. It can be challenging to manage a network with many devices all having different network-related attributes.

It is within this context that the embodiments herein arise.

### BRIEF DESCRIPTION OF THE DRAWINGS

FIG. 1 is a diagram of an illustrative system having a network access control and management server in accordance with some embodiments.

FIG. 2 is a diagram of an illustrative network access control and management server configured to maintain information on service and/or component failure events in accordance with some embodiments.

FIG. 3 is a flow chart of illustrative operations for predicting and handling cloud infrastructure failures in accordance with some embodiments.

### DETAILED DESCRIPTION

A method of operating a network access control and management server is provided. The network access control and management server can be used to provide one or more services relating to network access control and management of a network. The network access control and management server can be configured to predict a failure of the server based on a failure prediction model. The network access control and management server can also be configured to perform a remedial action to minimize any disruption in the services provided by the server. The remedial action can include adding or removing compute or storage capacity of the server and/or restarting one or more faulty components associated with the one or more services relating to network access control and management of the network.

The network access control and management server can further be configured to detect a failure that has occurred at the server and to obtain information relating to the detected failure. The server can further be configured to generate the failure prediction model based on the information relating to the detected failure that has occurred at the server. The server can further be configured to alert a user or administrator of the server in response to predicting the failure at the server and to provide a recommendation to the user or administrator for preventing the predicted failure. The server can further be configured to provide the user or administrator with an opportunity to follow the recommendation and to automatically reconfigure the server based on an input from the user. The network access control and management server can also be configured to perform a preemptive action to prevent any disruption in the services provided by the server.

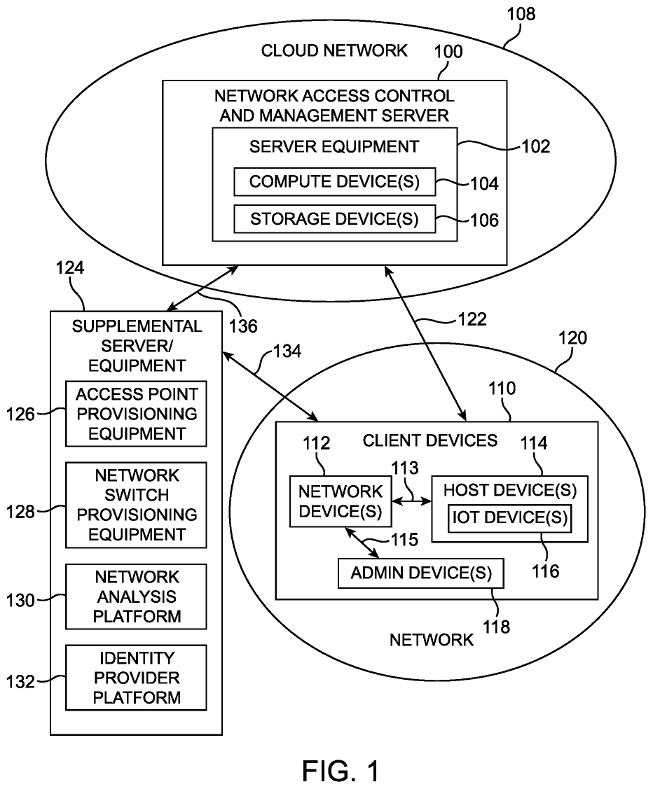

FIG. 1 shows an illustrative networking system that includes a server such as network access control and management server 100. Network access control and management server 100 may be formed from server equipment 102 containing any suitable number of compute devices 104 and any suitable number of storage devices 106.

As an example, server equipment 102 may include server hardware such as blade servers, rack servers, tower servers, micro servers, graphics processing unit (GPU) servers, data storage servers, and enterprise servers. Configurations in which server equipment 102 includes rack servers mounted to racks of a server chassis or enclosure are sometimes described herein as an illustrative example. Each of compute devices 104 and/or storage devices 106 may be provided as part of the server hardware (e.g., as part of rack servers).

Compute devices 104 may include one or more processors or processing units based on central processing units (CPUs), graphics processing units (GPUs), microprocessors, general-purpose processors, host processors, microcontrollers, digital signal processors (DSPs), programmable logic devices such as a field programmable gate array devices (FPGAs), application specific system processors (ASSPs), application specific integrated circuits (ASICs), and/or other types of processors. Storage devices 106 may include non-volatile memory (e.g., flash memory or other electrically-programmable read-only memory configured to form a solid-state drive), volatile memory (e.g., static or dynamic random-access memory), hard disk drive storage, solid-state storage, and/or other storage circuitry. More specifically, storage devices 106 may include non-transitory (tangible) computer readable storage media configured to store the operating system software and/or any other software code, sometimes referred to as program instructions, software, data, instructions, or code. Compute devices 104 may run (e.g., execute) an operating system and/or other software/firmware that is stored on storage devices 106 to perform desired operations of server 100. In such a manner, server equipment 102 may implement one or more services, one or more software servers, and/or other software features to collectively perform the functions of network access control and/or network management for server 100. As described herein, server 100 can refer to the underlying server (hardware) equipment and/or the server software (e.g., services) executed thereon to perform the operations of server 100.

Network access control and management server 100 may be configured to provide network policy reception, definition, monitoring, and enforcement (e.g., reception, definition, and enforcement of network access policy and/or security policy via virtual local area networks (VLANs), access control lists (ACLs), vendor-specific attributes (VSAs), and/or other policy-defining features), natural language query, processing, and response (e.g., a chat interface for outputting network information and network configuration assistance and recommendation based on natural language user input), network-connected device profiling (e.g., the gathering, storage, and analysis of network-connected device information to facilitate network policy recommendations and/or other network configuration recommendations), predictive failure event handling (e.g., prediction and handling of future expected (yet-to-occur) failure events associated with server infrastructure and/or network configuration), network authentication (e.g., authentication for user and/or user device(s) connected to the network), public key infrastructure (PKI) (e.g., includes a certificate authority, a certificate issuance service, a certification validation and/or status lookup service, a certificate database, etc.), interfacing and integration services with external applications and/or servers (e.g., obtain network and/or user information from and distribute network and/or user information to external equipment), and device and/or user onboarding (e.g., registration and storage of user and/or user device information), as just a few examples. In general, server 100 may perform any suitable functions for network access control and management.

A “network access policy” (sometimes referred to as network access control policy) can refer to and be defined herein as a set of rules and guidelines that dictate how client devices can connect to and interact with one another in a computer network. Network access policies lay out the permissions, restrictions, and protocols governing network access and usage to ensure security, integrity, and availability of computing resources. For example, network access policies can include policies relating to how devices must authenticate their identities to gain access to the network, access control lists or ACLs (e.g., lists of rules indicating which files, folders, or resources are accessible to specific users or groups), network segmentation to ensure isolation from different network segments to help increase the overall security, encryption requirements, firewall rules, remote access requirements, policies that govern the types of devices allowed to connect to a certain part of the network, guidelines for keeping the devices up to date with the latest security patches or updates, policies for monitoring network activities and events for potential breaches, and/or other rules and policies.

Server 100 may be implemented as a part of a cloud network such as cloud network 108. Cloud network 108 may include one or more network devices such as switches (e.g., multi-layer switches), routers, gateways, bridges, hubs, repeaters, firewalls, wireless access points, devices serving other networking functions, devices that includes a combination of these functions, or other types of network devices. Multiple such network devices (e.g., network devices of different types or having different functions) may be present in cloud network 108 and interconnected therebetween and with other network devices to form a cloud network that forwards traffic to and from portions (e.g., different parts of server equipment 102) of server 100 serving as end hosts of cloud network 108. Configurations in which server 100 is implemented on public cloud infrastructure (e.g., cloud network 108 is a public cloud network) are sometimes described herein as an illustrative example. If desired, server 100 may be implemented on a private cloud network or an on-premise network.

Network access control and management server 100 may communicate with client devices 110 such as one or more network device(s) 112, one or more host device(s) 114, and network administrator devices 118, which are used to configure and administer other network devices. Host devices 114 can include Internet-of-Things (IOT) devices 116 such as network-connected appliances or device such as network-connected cameras, thermostats, smoke detectors, medical or health sensors which are sometimes referred to as Internet-of-Medical-Things (IOMT) devices, or other sensors, lighting fixtures, voice-controlled speakers, printers, or other output devices, controllers or other input devices, cars, wearable devices, and other network-connected equipment that serve as input-output devices and/or computing devices in the distributed networking system. In some illustrative arrangements described herein as an illustrative example, communication between server 100 and at least some host devices 114 (e.g., IOT devices 116) may occur via network devices 112 and links 113 (e.g., network devices 112 may forward network traffic between server 100 and host devices 114 to facilitate communication therebetween). Client devices 110 may form part of network 120 for which server 100 provides the above-mentioned functions (e.g., network access control and management functions containing any combination of network policy handling, natural language query handling, network-connected device profiling, predictive failure event handling, network authentication, public key infrastructure (PKI) services, interfacing and integration services with external applications and/or servers, device and/or user onboarding, etc.).

Host devices 114 may serve as end hosts of network 120 connected to each other and/or connected to other end hosts of other networks (e.g., server 100 of cloud network 108) via network devices 112 using communication paths 113. User devices such as administrator devices 118 may perform network administration for network devices 112, while other user devices may serve as end host devices 114. Network devices 112 may include switches (e.g., multi-layer switches), routers, gateways, bridges, hubs, repeaters, firewalls, access points, modems, load balancers, devices serving other networking functions, devices that include a combination of these functions, or other types of network devices.

Network access control and management server 100 may provide network access control and network management services for network 120 by communicating with network devices 112 and/or host devices 114 via communication paths 122. To facilitate network access control and network management, server 100 may communicate with other supplement servers and/or equipment 124. These supplemental servers 124 may include network management and network device management equipment such as wireless access point provisioning (and/or management) equipment 126 (e.g., a wireless access point management server), network switch provisioning (and/or management) equipment 128 (e.g., a network switch management server), and/or other network device management equipment that communicate with network devices 112 (e.g., to supply provisioning and/or configuration data, to receive network performance metrics data, and/or to exchange other suitable information).

Supplemental servers and equipment 124 may include one or more network analysis platforms 130 such as servers and/or services that provide analysis of network performance by way of providing endpoint visibility and security analysis (e.g., based on network traffic to and/or from host devices 114). Supplemental servers and equipment 124 may further include platforms that provide additional contextual information for the network, the users on the network, and/or the devices on the network such as identity provider platform 132 (e.g., servers and/or services that provide user identity authentication, a single sign-on (SSO) provider platform). In particular, supplemental server and/or equipment 124 may communicate with components of network 120 (e.g., network devices 112 and host devices 114) to supply provisioning, configuration, and/or control data, to receive network, device, and/or user information, and/or to otherwise exchange information therebetween via communications paths 134. Supplemental server and/or equipment 124 may communicate with server 100 (e.g., different portions of server equipment 102) to transmit the received network, device, and/or user information, to receive network access control and/or management information, and/or to otherwise exchange information therebetween via communications paths 136.

Configurations in which equipment 126 and 128 and other network device management equipment refer to server equipment (e.g., similar to server equipment 102) on which network device provisioning and/or management software are executed are sometimes referred to herein as an illustrative example. Similarly, configurations in which network analysis platform 130 and identify provider platform 132 are cloud-based platforms (e.g., applications executed on server equipment) are sometimes described herein as an illustrative example. In these examples, servers and/or equipment 124 may be implemented within the same cloud network as or different cloud networks than server 100. If desired, any of supplement servers and/or equipment 124 may be implemented locally (e.g., local to network 120) instead of as a cloud application (e.g., implemented on a cloud server) or may be implemented in other desired manners.

The networking system in FIG. 1 (e.g., the combination of cloud network 108, network 120, and equipment 124) may span any suitable scope depending on the implementations of servers 100 and 124. Communication paths 122, 134, and 136 may be implemented according to the scope of the networking system. Configurations in which one or more of communication paths 122, 134, and 136 include the Internet are sometimes described herein as an illustrative example. In particular, any of communications paths 122, 134, and 136 may use Hypertext Transfer Protocol Secure (HTTPS), Remote Authentication Dial-In User Service (RADIUS) with Transport Layer Security (TLS) encryption (e.g., RadSec), Secure Shell (SSH), Internet Protocol Security (IPSec), Secure File Transfer Protocol (SFTP), or other secure protocols for establishing and communicating using the corresponding communications paths.

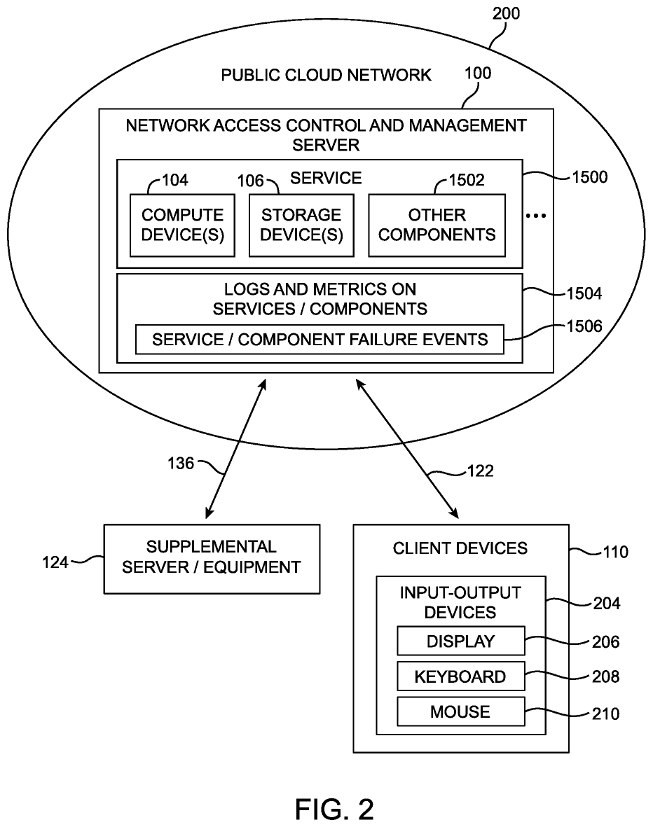

FIG. 2 is a diagram of an illustrative network access control and management server 100 on which one or more services are executed and on which server and component failure information can be maintained. As shown in FIG. 2, network access control and management server 100 may be implemented or run on a public cloud network 200. Server 100 may run or execute a number of services (e.g., micro-services) for one or more applications. The applications or the service(s) therefor may provide network policy reception, definition, and enforcement, natural language query, processing, and response, network-connected device profiling, predictive failure event handling, network authentication, public key infrastructure (PKI), interfacing and integration services with external applications and/or servers, and device and/or user onboarding, as examples.

Server 100 may be configured to run one or more services 1500 for different customers or tenants. Each service 1500 may be executed using one or more compute device 104, one or more storage devices 106, and/or other components 1502 (e.g., power supply and management devices such as voltage supplies, power management integrated circuits, etc., temperature management devices such as temperature sensors, heat sinks, etc., and other portions of server equipment). The level of service, performance, and availability that a network provider offers to its customer can be outlined in a network service level agreement (SLA). A service level agreement outlines specific metrics, responsibilities, and expectations between the network/service provider and each customer. A network provider can offer different service level agreements to different customers. A service level agreement can include a description of the service(s) provided including the type of network and available bandwidth, service availability such as the expected uptime and downtime, performance metrics such as the expected latency and packet loss, response time such as how quickly the service provider can recover from outages or major/minor incidences, and security and compliance measures the security provider will adhere to, just to name a few.

To help ensure that a network provider can meet the requirements of the service level agreement with each customer and to facilitate the management of server infrastructure (e.g., the server or service software and/or the hardware on which the software is executed), network access control and management server 100 may obtain and maintain a database 1504 of logs and metrics on the (software) performance of the services and on the hardware components. If desired, the logs and metrics in database 1504 may be obtained from or generally accessible via a server management platform (e.g., that manages the configuration of server equipment such as the number compute and/or storage devices provided for each server). If desired, the logs and metrics in database 1504 may include information on the number and type of client devices 110 connected to server 100 (e.g., to each service) via communications links 122 and the number and type of supplemental server(s) and/or equipment connected to server 100 (e.g., to each service) via communications links 136, may include information on the quality or other characteristics (e.g., bandwidth) of links 122 and 136, and/or may include other operational and performance metrics data.

Client device 110 may include input-output devices 204 such as display 206, keyboard 208, mouse 210, as just a few examples. Display 206 may supply a user with output for a user interface (e.g., display a web browser application with a graphical user interface) and the user may interact with the user interface using keyboard 208 and mouse 210 (e.g., supply input for the web browser application via the graphical user interface).

In accordance with some embodiments, one way to ensure that the terms of the SLAs are satisfied is to detect or predict network failures or failure events using server 100. To facilitate the detection of server/network infrastructure failure events, server 100 may track, in database 1506, the occurrence of any past server infrastructure failure events and the associated context in which the failure event occurred (e.g., as indicated by the log information and/or metrics data such as the number of compute and/or storage devices used for a service shortly prior to failure, temperatures, supply voltages, and/or other operating parameters of the server equipment shortly prior to failure, client devices accessing the service shortly prior to failure, supplemental server(s) connected to the server shortly prior to failure, etc.). In general, each service and/or component failure event identified in database 1506 may be accompanied by and/or associated with the logs and metrics data of the failed service and/or failure component around the time of failure (e.g., during a time period prior to failure).

Network access control and management server 100 may apply machine learning or other types of predictive model using the information in databases 1504 and 1506 to perform predictions of future service and/or component failure (e.g., to preemptively identify the contexts or scenarios in which failure is likely to occur). In such a manner, server 100 may take corrective action(s) prior to or in anticipation of an expected future service and/or component failure.

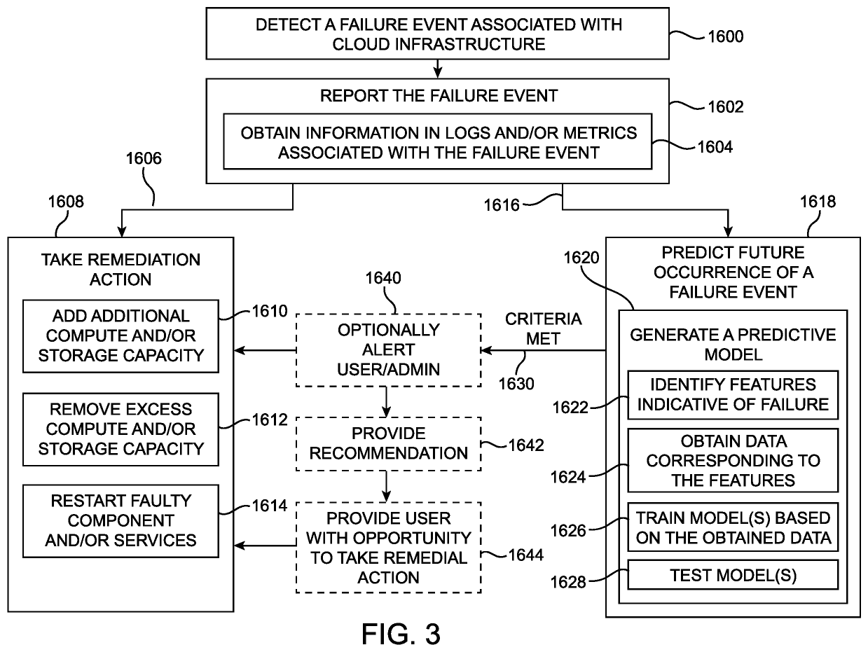

FIG. 3 is a flowchart of illustrative steps for predicting and handling service and/or component failure events. As an example, the operations described in connection with FIG. 3 may be performed using network access control and management server 100 of the type shown in FIGS. 1 and 2.

During the operations of block 1600, server 100 may observe one or more failure events associated with the server infrastructure (e.g., to observe or detect a failure of one or more hardware and/or software components of service 1500 running on public cloud network 200 such as a software failure of the service and/or a hardware failure of the compute device(s) executing the service software). The failure(s) observed during block 1600 may represent past failure(s) that have previously occurred at server 100 or some failure associated with the infrastructure of server 100.

During the operations of block 1602, server 100 may report the observed failure event(s). For example, server 100 can report the observed failure(s) to a cloud network administrator device or a server management platform and/or record the detected failure internally at database 1506 (see FIG. 2). Accordingly, to populate a failure event entry in database 1506, server 100 may obtain information in a logs and/or metrics database (e.g., database 1504) to associate with the failure event. The obtained information may include a number of compute devices in use when the failure occurred, a number of storage devices in use when the failure occurred, a supply voltage, temperature, or other characteristic of the server equipment when the failure occurred, a software version of the service running when the failure occurred, and/or any other suitable information that could be indicative of a causation of the failure.

In response to the observed and subsequently reported failure(s), server 100 may proceed (via path 1606) to take one or more remedial actions at block 1608. As examples, server 100 may add additional compute and/or storage capacity such as to configure additional compute and/or storage blocks or devices to perform operations of the service (see block 1610), may remove excess compute and/or storage capacity by reconfiguring some existing compute and/or storage devices to not perform operations of the service (see block 1612), and/or may restart (reboot) faulty hardware component(s) and/or software service(s) (see block 1614).

In accordance with some embodiments, server 100 can also be configured to preemptively perform corrective actions in anticipation of a cloud infrastructure failure event instead of taking remediation actions in response to a cloud infrastructure failure event that has occurred. Accordingly, the reporting of the failure event and the corresponding logs and metrics information at block 1602 may help anticipate or predict future cloud infrastructure failure events.

As shown in FIG. 3, after processing block 1602, server 100 may proceed (via path 1616) to perform operations of block 1618 (e.g., to predict one or more future occurrences of server infrastructure failure events such as events similar to those previously detected at block 1600). As part of performing the prediction operations of block 1618, server 100 may generate a predictive model at block 1620 by performing the operations of blocks 1622, 1624, 1626, and 1628. The predictive model may be generated based on past failure data obtained from the operations of blocks 1600 and 1602. Such a predictive model for anticipating future occurrences of server-level infrastructure failure(s) can sometimes be referred to and defined herein as a “server failure prediction model.”

During the operations of block 1622, server 100 may identify one or more features, characteristics, or behaviors indicative of a server infrastructure failure. In particular, server 100 may determine, based on the information obtained at block 1604, that one or more features are most likely to cause (e.g., are predictors or predictive features of) future server infrastructure failure events. As examples, predictive features may include a number of compute devices (blocks), a number of storage devices (blocks), a version of the operating system or firmware for the compute and/or storage devices, a supply voltage, temperature, or other operating characteristic/condition of server equipment, a software version of the service, a number of client devices connected to the service, types of client devices connected to the service, a number of supplemental servers, types of supplemental servers connected to the service, and/or any other suitable predictive information.

During the operations of block 1624, server 100 may obtain data corresponding to the one or more identified features from database 1506. The obtained data may be used to characterize how likely a failure is to occur (e.g., to compute a probability of a server failure).

During the operations of block 1626, server 100 may train one or more models (e.g., one or more server failure predictive models) based on the data obtained during block 1624. As an example, server 100 may train a machine learning (ML) model to recognize a pattern of the obtained data (for the combination of features) as a predictor of a failure event. Such machine-learning based predictive model can be used to predict or estimate a timing of the failure event, a probability of the failure event, and/or of a confidence level of the prediction.

At block 1628, server 100 may optionally test the machine-learning based predictor model(s). As an example, server 100 may provide test data to the trained machine learning model and monitor/analyze the output of the machine learning model to determine an accuracy of the model based on a comparison of the output of the machine learning model to the actual observed non-failure or failure (e.g., whether or not a failure occurred when the input parameters are observed).

After a suitable learning and/or testing period (e.g., after a suitable number of iterations of the operations of blocks 1626 and 1628), server 100 may use the trained predictive model to analyze logs and/or metrics (e.g., at database 1504) in real-time. The learning period can last for days, weeks, or months, depending on the desired confidence level. A longer learning/testing period will generally produce a higher confidence level, albeit at diminishing marginal returns.

Once such a machine-learning based service failure prediction model is ready, the processing of server 100 may start at block 1618. In response to one or more detection criteria being met (e.g., if the predictive model determines that the analyzed information is likely to result in a failure event within a certain time period with a confidence level greater than some threshold), server 100 may proceed via path 1630.

In response to one or more detection criteria being met as shown by path 1640, server 100 may take one or more remedial actions as described in connection with blocks 1608, 1610, 1612, and 1614. Such remediation actions performed as a result of the prediction at block 1618 may be corrective actions that avoid or prevent the occurrence of a predicted future server infrastructure failure event rather than a remediation action that is taken after the occurrence of a server infrastructure failure event. Operating a system in this way can be technically advantageous and beneficial by allowing the overall system to operate with minimal network/server disruption so that the service level agreements with the various customers are maintained while reducing operational complexity.

If desired, one or more optional steps such as the operations of blocks 1640, 1642, and 1644 can be taken in response to one or more failure detection criteria being met. During the operations of block 1640, server 100 may optionally alert a user/administrator of a predicted failure detected at block 1618. Server 100 may present a message or other types of user alert on display 206 of client device 110 of the possibility or probability of a server failure event (as an example). Server 100 can output different types of failures that are likely to occur with their respective probabilities. During the operations of block 1642, server 100 can provide one or more recommendations to the user/admin for preventing or avoiding the future occurrence of such failure(s). Server 100 can optionally provide a different recommendation for each different type of failure(s) if multiple failures are predicted or expected to occur. As an example, server 100 can detect that a server failure is likely to occur due to a shortage of compute and/or storage capacity and may, in response, provide a recommendation to configure additional compute and/or storage blocks for the server. As another example, server 100 can detect that a server failure is likely to occur due a malfunction in one or more hardware and/or software blocks associated with the server and may, in response, provide a recommendation to restart (reboot) the malfunctioning hardware and/or software blocks. As another example, server 100 can detect that a server failure is likely to occur due to an older version of an operating system or firmware and may, in response, provide a recommendation to update the operating system or firmware. As another example, server 100 can detect that a server failure is likely to occur due to an excessive number of clients currently connected to the server and may, in response, provide a recommendation to limit the number of clients.

During the operations of block 1644, server 100 may provide the user/admin with an opportunity to take some remedial action. For example, the user can select from among a list of recommendations provided at block 1642. In response to a selection from the user, server 100 can automatically reconfigure server 100 based on the selection. If the user does not select a remedial action, server 100 may not perform any preventative measures to avoid a future failure. In other embodiments, server 100 may automatically perform a preventative measure that is most likely to avoid or circumvent the predicted future failure even when the user does not select a remedial action. The operations of blocks 1640, 1642, and 1644 are optional.

The operations of FIG. 3 are exemplary. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

The methods and operations described above in connection with FIGS. 1-3 may be performed by the components of one or more network devices and/or server or other host equipment using software, firmware, and/or hardware (e.g., dedicated circuitry or hardware). Software code for performing these operations may be stored on non-transitory computer-readable storage media (e.g., tangible computer readable storage media) stored on one or more of the components of the network device(s) and/or server or other host equipment. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server or other host equipment (see, e.g., FIG. 1, using server equipment 102 on server 100, supplemental server equipment 124, processing equipment on client device 110, or other processing circuitry on a private or public network, etc.).

The foregoing is merely illustrative and various modifications can be made to the described embodiments. The foregoing embodiments may be implemented individually or in any combination.

What is claimed is:

1. A method for operating a server comprising:
with the server, providing one or more services relating to network access control and management of a network;
with a server failure prediction model, predicting a failure of the server; and
performing a remedial action to avoid disruption in the one or more services relating to network access control and management of the network.

2. The method of claim 1, further comprising:
detecting a failure that has occurred at the server; and
obtaining information relating to the detected failure that has occurred at the server.

3. The method of claim 2, further comprising:
generating the server failure prediction model based on the information relating to the detected failure that has occurred at the server.

4. The method of claim 3, wherein generating the server failure prediction model comprises identifying one or more features indicative of a server failure.

5. The method of claim 4, wherein generating the server failure prediction model further comprises obtaining data relating to the one or more identified features.

6. The method of claim 5, wherein obtaining the data relating to the one or more identified features comprises determining a number of compute devices in use by the server when the detected failure occurred at the server or determining a number of storage devices in use by the server when the detected failure occurred at the server.

7. The method of claim 5, wherein obtaining the data relating to the one or more identified features comprises determining an operating condition of equipment associated with the server when the detected failure occurred at the server.

8. The method of claim 5, wherein obtaining the data relating to the one or more identified features comprises determining a version of an operating system, software, or firmware being run by the server when the detected failure occurred at the server.

9. The method of claim 5, wherein obtaining the data relating to the one or more identified features comprises determining a number of client devices that are connected to the network or determining types of client devices that are connected to the network when the detected failure occurred at the server.

10. The method of claim 5, wherein generating the server failure prediction model further comprises training the server failure prediction model based on the obtained data relating to the one or more identified features.

11. The method of claim 10, wherein generating the server failure prediction model further comprises testing the server failure prediction model based on test data.

12. The method of claim 1, further comprising:
in response to predicting a failure of the server, alerting a user or administrator of the server; and
providing a recommendation to the user or administrator for preventing the predicted failure.

13. The method of claim 12, further comprising:
providing the user or administrator with an opportunity to follow the recommendation; and
in response to receiving an input from the user or administrator to follow the recommendation, automatically reconfiguring the server based on the received input.

14. The method of claim 1, wherein performing a remedial action to avoid disruption in the one or more services relating to network access control and management of the network comprises adding or removing compute or storage capacity for the server.

15. The method of claim 1, wherein performing a remedial action to avoid disruption in the one or more services relating to network access control and management of the network comprises restarting one or more faulty components associated with the one or more services relating to network access control and management of the network.

16. One or more non-transitory computer-readable storage media storing computer-executable instructions that, when executed by one or more processors associated with a server, cause the one or more processors to:
provide one or more services relating to network access control and management of a network;
predict a failure of the server; and
perform a remedial action that avoids disruption in the one or more services relating to network access control and management of the network.

17. The one or more non-transitory computer-readable storage media of claim 16, further comprising computer-executable instructions that, when executed by the one or more processors, cause the one or more processors to:
generate a predictive model for anticipating the failure of the server.

18. The one or more non-transitory computer-readable storage media of claim 16, further comprising computer-executable instructions that, when executed by the one or more processors, cause the one or more processors to:
alert a user of the server in response to predicting the failure; and
provide a recommendation to the user for preventing the failure.

19. The one or more non-transitory computer-readable storage media of claim 16, wherein the computer-executable instructions that cause the one or more processors to perform the remedial action comprises computer-executable instructions that cause the one or more processors to add compute or storage capacity for the server, to remove compute or storage capacity for the server, or to reboot one or more faulty components associated with the one or more services relating to network access control and management of the network.

20. A method of operating a network access control and management server, comprising:
detecting a failure of the network access control and management server that is configured to provide one or more services;
gathering information associated with the detected failure;
generating a failure prediction model based on the gathered information; and
with the failure prediction model, predicting an additional failure of the server that will impact the one or more services provided by the network access control and management server.
